(19) United States
(12) Patent Application Publication
(10) Pub. No.: US 2003/0184653 A1
(43) Pub. Date: Oct. 2, 2003

(54) Method, apparatus, and program for classifying images

(76) Inventor: Akito Ohkubo, Kanagawa-ken (JP)

Correspondence Address: BIRCH STEWART KOLASCH & BIRCH, PO BOX 747, FALLS CHURCH, VA, 22040-0747, US

(21) Appl. No.: 10/400,537

(22) Filed: Mar. 28, 2003

(30) Foreign Application Priority Data
Mar. 29, 2002 (JP) 2002-096145

(51) Int. Cl. H04N 5/225

(52) U.S. Cl. 348/207.1

(57) ABSTRACT

Image data sets are classified into an event in which the image data sets were obtained. A user sends the image data sets to an image storage server. Tag information reading means in image classification means reads tag information added to the image data sets. The image classification means reads calendar information describing an event period from information database, and classifies the image data sets into the event based on photography date information described in the tag information and the calendar information, to generate classification information. The classification information is stored in a storage database together with the image data sets and thumbnail image data sets of the image data sets.

### BACKGROUND OF THE INVENTION

1. Field of the Invention

The present invention relates to an image classification method and an image classification apparatus for classifying image data sets obtained by a digital camera or by reading images recorded on a photographic film such as a negative film. The present invention also relates to a program that causes a computer to execute the image classification method.

2. Description of the Related Art

Prints generated from silver salt photographic films have been used in various manners. For example, such prints are used for checking how photographs look, or used for communication with friends by showing the prints thereto. In other cases, additional prints or enlargements are generated to be sent to friends or to be used for display, and the prints are stored in photograph albums.

Meanwhile, images are also managed by using image data sets obtained by photography with a digital camera or by reading images recorded on a negative photographic film. When such image data sets are stored, a user who stores the image data sets generates folders corresponding to events or the date of photography, and manually classifies the image data sets into the folders while confirming the images.

However, classifying the image data sets becomes more troublesome as the number of the image data sets grows. Especially, in the case of a digital camera, a large amount of image data sets are often generated since digital cameras do not require a film development charge. Therefore, various methods of automatically classifying image data sets have been proposed, such as classification according to a recording medium in which the image data sets were recorded or according to a photographic film from which the image data sets were obtained, and classification into folders having a hierarchical structure such as the day, month, and year. Furthermore, methods of classifying image data sets according to the date of photography based on information representing the date and time of photography have also been proposed (Japanese Unexamined Patent Publication Nos. 5(1993)-165935 and 2001-228528). In addition, a method of classifying image data sets in detail by classification according to the date and time of photography and by further classification according to a similarity of images has been proposed (Japanese Unexamined Patent Publication No. 2000-112997). Moreover, a method of classifying image data sets obtained by a digital camera according to the orientation of the camera at the time of photography and according to images having the same time information has also been proposed (U.S. Pat. No. 5,576,759).

By using such methods for automatic classification of image data sets, a user can efficiently organize his/her image data sets.

Meanwhile, users often take photographs on trips during consecutive holidays or during summer vacations. In this case, image data sets are obtained over a plurality of photography dates for one event. However, by using the methods described in Japanese Unexamined Patent Publication No. 5(1993)-165935 and the like, the image data sets can be classified only according to the date of photography or according to a recording medium or photographic film, but cannot be classified according to each event lasting over a number of days. For this reason, if the image data sets obtained in such events during consecutive holidays are classified according to any one of the methods described above, the image data sets are classified according to the date of photography. Therefore, a user ends up classifying the image data sets again by a manual operation for each of the events.

### SUMMARY OF THE INVENTION

The present invention has been conceived based on consideration of the circumstances described above. An object of the present invention is therefore to classify image data sets according to events during which the image data sets were obtained.

An image classification method of the present invention is a method of classifying image data sets added with accompanying information including information on date and time of photography. The image classification method comprises the steps of:

obtaining the information on the date and time of photography from the image data sets; and

classifying the image data sets into a group or groups corresponding to a predetermined event related to a plurality of dates of photography, based on the information on the date and time of photography.

The accompanying information refers to not only the information on the date and time of photography but also information on a location of photography, user information for identifying a user as a photographer, and analysis information obtained by analyzing the image data sets, for example. Tag information of the image data sets can be used as the accompanying information.

The photographer may include the photography location information in the accompanying information by a manual operation. Alternatively, in the case where the image data sets have been obtained by a digital camera having a GPS function, GPS information is included as the photography location information in the accompanying information.

The analysis information refers to the number of human faces or a color distribution in each of images represented by the image data sets, for example.

The accompanying information is added to the image data sets by a digital camera in the case where the image data sets have been obtained by the digital camera. In the case where the image data sets have been obtained by reading images recorded on a photographic film or the like with use of reading means such as a scanner, the reading means adds the accompanying information to the image data sets.

The predetermined event refers to Golden Week holidays, year-end holidays, consecutive holidays on a calendar, weekends, a summer vacation, personal days off, and personal events, for example.

In the image classification method of the present invention, calendar information that relates the predetermined event to the dates of photography may be obtained so that the image data sets can be classified according to the calendar information in addition to the information on the date and time of photography.

In the image classification method of the present invention, the calendar information may be obtained from calendar information storing means that stores a plurality of pieces of calendar information corresponding to a plurality of pieces of accompanying information.

In this case, a desired one of the pieces of calendar information is obtained from the pieces of calendar information according to the accompanying information added to the image data sets so that the image data sets can be classified according to the desired piece of calendar information in addition to the information on the date and time of photography.

The plurality of pieces of calendar information corresponding to the plurality of pieces of accompanying information refer to calendar information corresponding to each photography location, each user, and the analysis information. In other words, the calendar information storing means stores the plurality of pieces of calendar information corresponding to each photography location, each user, and the analysis information.

Each photography location refers to a location in which an event depending on the date becomes different, such as a country, a region, the Northern hemisphere, or the Southern hemisphere.

In the image classification method of the present invention, a time period of the predetermined event may be inferred based on the accompanying information added to the image data sets so that the image data sets can also be classified according to a result of inference on the time period.

In the image classification method of the present invention, the image data sets that have been classified may further be classified into groups having a hierarchical structure.

In the image classification method of the present invention, classification information representing a result of classification of the image data sets may be output.

In this case, the image data sets may be displayed in the classification according to the classification information.

An image classification apparatus of the present invention is an apparatus for classifying image data sets added with accompanying information including information on date and time of photography. The image classification apparatus of the present invention comprises:

photography date/time information obtaining means for obtaining the information on the date and time of photography from the image data sets; and

image classification means for classifying the image data sets into a group or groups corresponding to a predetermined event related to a plurality of dates of photography, based on the information on the date and time of photography.

In the image classification apparatus of the present invention, the image classification means may obtain calendar information that relates the predetermined event to the dates of photography and classify the image data sets according to the calendar information in addition to the information on the date and time of photography.

The image classification apparatus of the present invention may further comprise calendar information storing means for storing a plurality of pieces of calendar information corresponding to a plurality of pieces of accompanying information so that the image classification means can obtain the calendar information that relates the predetermined event to the dates of photography from the calendar information storing means.

In this case, the image classification means obtains a desired one of the pieces of calendar information from the pieces of calendar information stored in the calendar information storing means according to the accompanying information added to the image data sets, and classifies the image data sets according to the desired piece of calendar information in addition to the information on the date and time of photography.

The image classification apparatus of the present invention may further comprise event period inference means for inferring a time period of the predetermined event based on the accompanying information added to the image data sets so that the image classification means can also classify the image data sets according to a result of inference on the time period.

In the image classification apparatus of the present invention, the image classification means may further classify the image data sets that have been classified into groups having a hierarchical structure.

The image classification apparatus of the present invention may further comprise output mans for outputting classification information representing a result of classification of the image data sets.

In this case, the image classification apparatus of the present invention may further comprise display means for displaying the image data sets in the classification according to the classification information.

The image classification method of the present invention may be provided as a program that causes a computer to execute the image classification method.

According to the present invention, the information on the date and time of photography is obtained from the image data sets, and the image data sets are classified into the group or groups for the predetermined event related to the dates of photography, according to the information on the date and time of photography. In other words, even in the case where the predetermined event lasts for days, the image data sets photographed on the days corresponding to the predetermined event can be classified into one group. Therefore, the image data sets can be classified into the predetermined event even in the case where the predetermined event lasts for days.

By obtaining the calendar information that relates the predetermined event to the dates of photography and by classifying the image data sets according to the calendar information in addition to the information on the date and time of photography, the image data sets can be classified more easily according to the event by referring to the calendar information.

By obtaining the calendar information from the calendar information storing means that stores the plurality of pieces of calendar information corresponding to the plurality of pieces of accompanying information, the desired piece of calendar information can be obtained easily.

In the case where the plurality of pieces of calendar information corresponding to the plurality of pieces of accompanying information are stored in the calendar information storing means, by obtaining the desired piece of calendar information based on the accompanying information of the image data sets and by classifying the image data sets into the group or groups based on the desired piece of calendar information, the image data sets can be classified into the event according to the accompanying information.

By inferring the event period from the accompanying information, the plurality of pieces of calendar information do not need to be prepared in advance. Therefore, a configuration of an apparatus that embodies the present invention can be simple.

By further classifying the image data sets into the groups having the hierarchical structure, the image data sets can be classified in further detail.

By outputting the classification information representing the classification result on the image data sets, the image data sets can be classified with reference to the classification information by an apparatus other than the apparatus of the present invention.

By displaying the image data sets in classification according to the classification information, the classification result can be easily recognized.

### BRIEF DESCRIPTION OF THE DRAWINGS

FIG. 1 is a block diagram showing a configuration of an image storage system adopting an image classification apparatus of a first embodiment of the present invention;

FIG. 2 is a diagram for explaining classification of image data sets;

FIG. 3 is a diagram showing a result of classification of the image data sets;

FIG. 4 is a flow chart showing the procedure carried out in the first embodiment;

FIG. 5 shows the result of classification of the image data sets displayed on a personal computer;

FIG. 6 is a flow chart showing the procedure carried out in a second embodiment of the present invention;

FIG. 7 is a block diagram showing a configuration of an image storage system adopting an image classification apparatus of a third embodiment of the present invention;

FIG. 8 is a flow chart showing the procedure carried out in the third embodiment;

FIG. 9 is a block diagram showing a configuration of an image storage system adopting an image classification apparatus of a fourth embodiment of the present invention; and

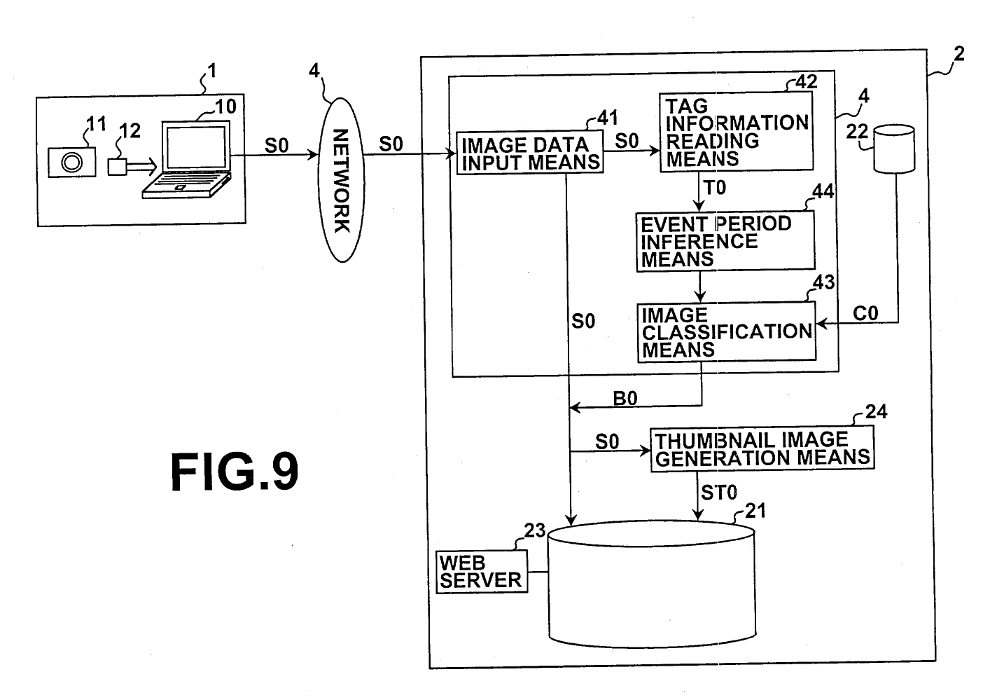

FIG. 10 is a flow chart showing the procedure carried out in the fourth embodiment.

### DESCRIPTION OF THE PREFERRED EMBODIMENTS

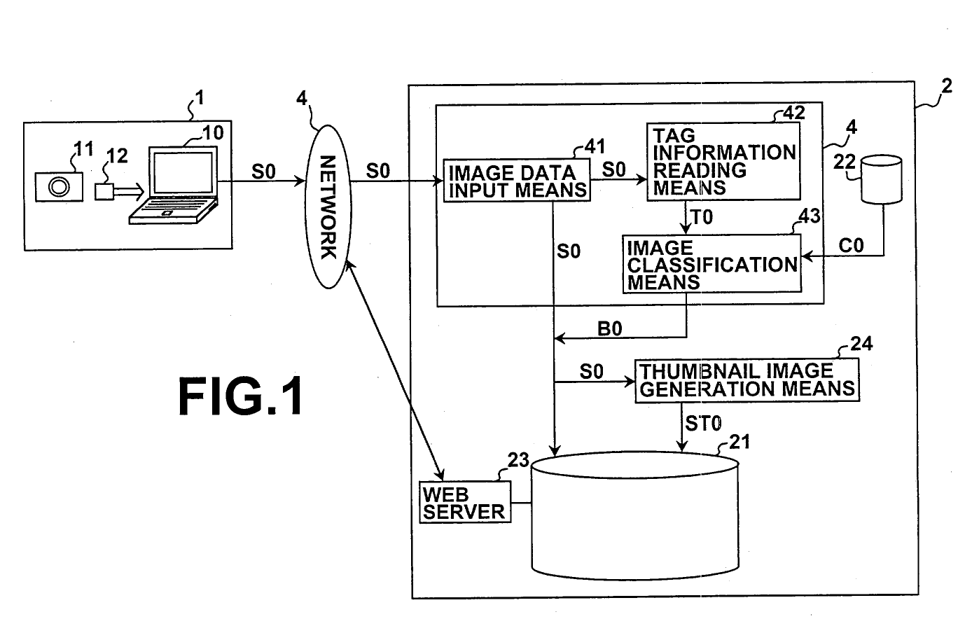

Hereinafter, embodiments of the present invention will be explained with reference to the accompanying drawings. FIG. 1 is a block diagram showing a configuration of an image storage system adopting an image classification apparatus of a first embodiment of the present invention. As shown in FIG. 1, the image storage system in the first embodiment exchanges data between a personal computer 10 of a user 1 and an image storage server 2 having the image classification apparatus of the present invention. The personal computer 10 of the user 1 and the image storage server 2 are connected to each other via a network 3.

The user 1 obtains image data sets S0 with use of a digital camera 11 of his/her own, and records the image data sets S0 in a memory card 12. The user 1 then reads the image data sets S0 from the memory card 12 while using the personal computer 10, and temporarily stores the image data sets S0 in a hard disc of the personal computer 10. When the user 1 requests classification of the image data sets S0, the user 1 sends the image data sets S0 to the image storage server 2 via the network 3.

When the image data sets S0 are obtained by the digital camera 11, information representing the date and time of photography (hereinafter referred to as the photography date information) is recorded in tag information T0 of each of the image data sets S0. In this embodiment, the digital camera 11 is assumed to have a GPS function. Therefore, photography location information representing the latitude and longitude of a photography location is also recorded in the tag information T0. In the case where the digital camera 11 does not have the GPS function, the user 1 manually inputs the name and address of the photography location to the digital camera 11 so that the photography location information can be recorded in the tag information T0, for example.

If necessary, the number of human faces included in each of the image data sets S0 is detected by the digital camera 11, and described in the tag information T0 to be added to each of the image data sets S0. Information on color distribution in each of the image data sets S0 obtained by analysis thereof is also described in the tag information T0 to be added to each of the image data sets S0.

The personal computer 10 has viewer software and general-purpose Web browser software installed therein for viewing the image data sets S0. The user 1 can view the image data sets S0 obtained by the digital camera 11 while using the viewer software, and can connect the personal computer 10 to the image storage server 2 by using the Web browser software in order to request classification of the image data sets S0 from the image storage server 2. In the case where the user 1 requests classification of the image data sets S0 from the image storage server 2, the image data sets S0 are sent to the image storage server 2 via the network 3. At this time, user information for identifying the user 1 is also sent to the image storage server 2. The user information may be described in the tag information T0 of each of the image data sets S0.

The image storage server 2 comprises a storage database 21 such as a hard disc or RAID, an information database 22, image classification means 4 according to the first embodiment of the present invention, a Web server 23, and thumbnail image generation means 24. The storage database 21 stores the image data sets S0, thumbnail image data sets ST0 that will be explained later, and information representing a result of classification. The information database 22 stores various kinds of information such as the user information. The Web server 23 enables the various kinds of information stored in the storage database 21 to be viewed via the network 3. The thumbnail image generation means 24 generates the thumbnail image data sets ST0 representing thumbnail images generated from images represented by the image data sets S0.

In this embodiment, the information database 22 stores calendar information C0, and the storage database 21 stores the image data sets S0, the thumbnail image data sets ST0, and classification information B0. In the image storage server 2, software for carrying out the functions of the means described above may be used, instead of the means.

The calendar information C0 relates the date of photography with an event. The event refers to Golden Week holidays, year-end holidays, consecutive holidays on a calendar, weekends, a summer vacation, private days off, and a personal event, for example. The event becomes different from country to country, and from region to region, and between the Northern hemisphere and the Southern hemisphere. For example, in Japan, Golden Week holidays and year-end holidays are available but not in the United States. On the contrary, Christmas holidays and Easter holidays are available in the United States but not in Japan. Furthermore, the Northern hemisphere has seasons the reverse to those of the Southern hemisphere. Moreover, national holidays become different among countries and among regions. Therefore, in the first embodiment, the calendar information C0 is stored in the information database 22, in relation to events in a country or region wherein the image data sets S0 are classified.

The user 1 requesting classification of the image data sets S0 has events and holidays that are different from those of the others. Therefore, the calendar information C0 maybe stored in the information database 22 while being related to the events regarding the user 1.

The image classification means 4 comprises image data input means 41 for receiving input of the image data sets S0, tag information reading means 42 for reading the tag information T0 added to the image data sets S0, and image classification means 43 for classifying the image data sets S0 into groups of the events according to the photography date information described in the tag information T0 and the calendar information C0, and for generating the classification information B0 representing the result of classification of the image data sets S0.

The image data input means 41 comprises a communication interface for receiving the image data sets S0 sent from the personal computer 10.

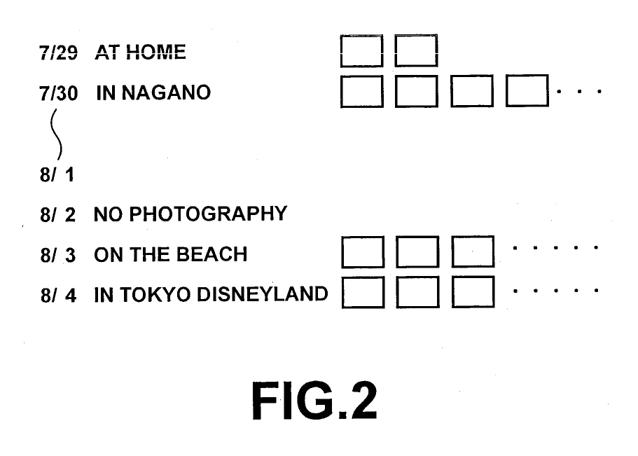

FIG. 2 is a diagram showing how the image data sets S0 are classified. In this case, the calendar information C0 representing the events regarding the user 1 has been recorded in the information database 22. The calendar information C0 describes that the user 1 was on summer vacation from Jul. 29 to Aug. 4, 2001.

As shown in FIG. 2, the user 1 spent his/her time at home on July 29 and carried out photography, then visited Nagano and carried out photography from July 30 to August 1. The user 1 did not carry out photography on August 2, then went to a beach and carried out photography on August 3. The user also visited Tokyo Disneyland on August 4 and carried out photography. The date and the user's whereabouts on the day have been recorded in the calendar information C0. In this manner, the user 1 has obtained the plurality of image data sets S0 during his/her summer vacation. The image data sets S0 have the photography date information described in the tag information T0 thereof. Therefore, by referring to the photography date information in the tag information T0, the date of photography can be known for each of the image data sets S0. By referring to the calendar information C0, the fact is known that the user 1 had the summer vacation from July 29 to August 4.

Therefore, the image classification means 43 classifies the image data sets S0 having the photography date from July 29 to August 4 into a group corresponding to an event “summer vacation”, with reference to the photography date information and the calendar information C0. More specifically, the image classification means 43 generates a folder titled “summer vacation”, and classifies the image data sets S0 into the folder.

In this embodiment, the user 1 did not carry out photography on August 2, during his/her summer vacation from July 29 to August 4. Therefore, no image data sets having the photography date information corresponding to the date exist. However, since the calendar information C0 describes the fact that the user 1 had the summer vacation from July 29 to August 4, the image data sets S0 can be classified into the group corresponding to the event “summer vacation” from July 29 to August 4.

By referring to the calendar information C0 in detail, the image data sets S0 can further be classified according to his/her whereabouts during the summer vacation. For example, the user 1 had spent his/her time at home on July 29, in Nagano from July 30 to August 1, on the beach on August 3, and in Tokyo Disneyland on August 4. Therefore, the image data sets S0 that have been classified into the group “summer vacation” can further be classified into groups corresponding to “home”, “Nagano”, “beach”, and “Disneyland”.

More specifically, folders titled “home”, “Nagano”, “beach”, and “Disneyland” are generated under the folder “summer vacation”, and the image data sets S0 obtained at the respective locations are classified into the corresponding folders.

By referring to the photography date information, the group “Nagano” can further be classified according to the date of photography. In other words, folders titled “7/30”, “7/31”, and “8/1” are generated so that the image data sets S0 are classified into the respective folders corresponding to the date of photography thereof.

In the case where the calendar information C0 describes the summer vacation as two periods from July 29 to August 1 and from August 4 to August 7, the image data sets S0 are classified into two groups corresponding to the two periods.

The image classification means 43 classifies the image data sets S0 in the above manner, and generates the classification information B0 representing the result of classification. With reference to the classification information B0, the image data sets S0 can be classified into the groups corresponding to the summer vacation.

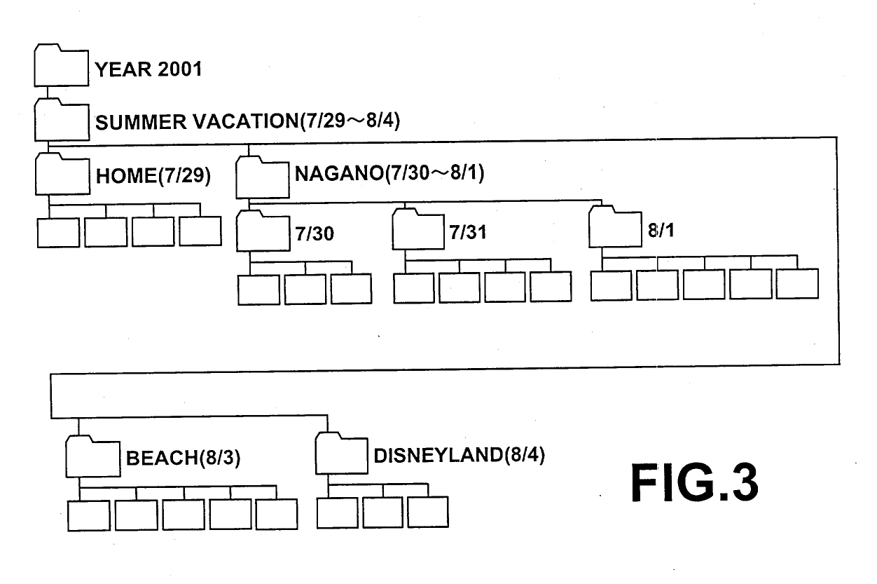

FIG. 3 shows the result of classification of the image data sets S0. As shown in FIG. 3, a folder “year 2001” has been generated to include the folder “summer vacation”. The folder “year 2001” includes the “summer vacation” folder, and the “summer vacation” folder includes the folders “home”, “Nagano”, “beach”, and “Disneyland”. The “Nagano” folder includes the folders “7/30”, “7/31” and “8/1”. Each of the image data sets S0 are stored in the folders of the lowest hierarchy. The folders and the image data sets S0 therein are sorted in chronological order of photography.

When the classification result is displayed, the image data sets S0 are displayed in their classified state as thumbnail image data sets ST0, with reference to the classification information B0.

Furthermore, if the tag information T0 describes the color distribution in the images represented by the image data sets S0, a similarity between the image data sets S0 may be found based on the color distribution. The image data sets S0 that have been classified according to the date of photography can then be classified in detail by grouping the image data sets S0, based on the similarity.

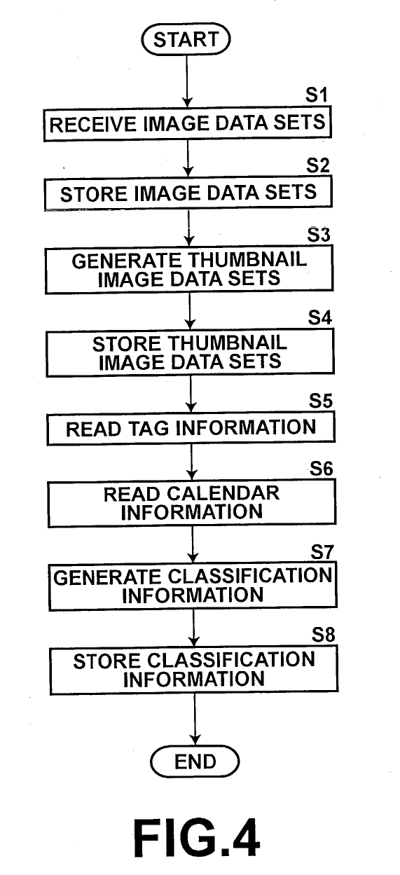

The operation of the first embodiment will be explained next. FIG. 4 is a flow chart showing the procedure carried out in the first embodiment. When the image data sets S0 obtained by photography with the digital camera 11 are sent from the personal computer 10 of the user 1 to the image storage server 2 via the network 3, the image data input means 41 of the image storage server 2 receives the image data sets S0 (Step S1). The image data sets S0 are stored in the storage database 21 (Step S2), and the thumbnail image generation means 24 generates the thumbnail image data sets ST0 from the image data sets S0 (Step S3). The thumbnail image data sets ST0 are also stored in the storage database 21 (Step S4).

Meanwhile, the tag information reading means 42 reads the tag information T0 added to the image data sets S0 (Step S5). The tag information is input to the image classification means 43. The image classification means 43 reads the calendar information C0 from the information database 22 (Step S6). The image classification means 43 then classifies the image data sets S0 according to the photography date information described in the tag information T0 and according to the calendar information C0, as has been described above, and generates the classification information B0 (Step S7). The classification information B0 is stored in the storage database 21 (Step S8) to end the procedure.

The order of carrying out the procedure at Steps S2, S3, S4, and at Steps from S5 to S8 is arbitrary. Therefore, the procedures thereat may be carried out in parallel.

The user 1 accesses the Web server 23 from his/her personal computer 10, and carries out an operation for displaying the classification result regarding the image data sets S0 he/she sent. The classification result is then displayed on the personal computer 10 according to the classification information B0.

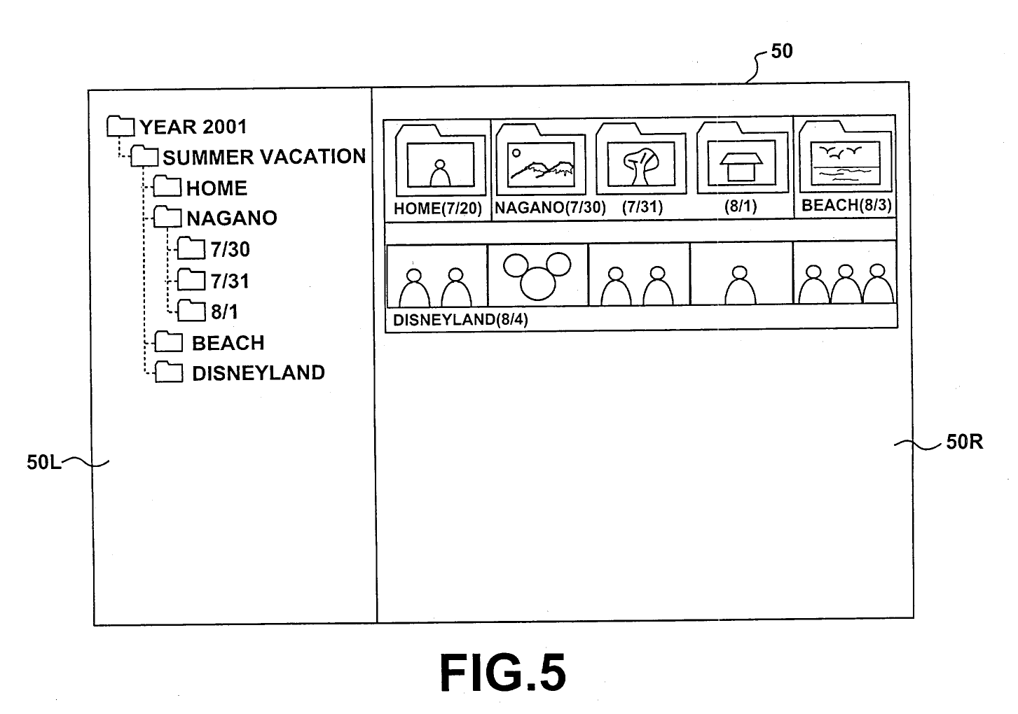

FIG. 5 shows the classification result displayed on the personal computer 10 regarding the image data sets S0. As shown in FIG. 5, the classification result is displayed as a classification result display page 50 on the personal computer 10. A folder structure of the classification result is displayed in a left-side frame 50L of the page 50. Representatives of the thumbnail images of the image data sets S0 classified into the folders are shown on a right-side frame 50R, by being displayed in folder icons. The user 1 can display the thumbnail images of the image data sets S0 stored in each of the folders by clicking the corresponding folder icon in the right-side frame 50R. In FIG. 5, the thumbnail images of the image data sets S0 classified into the folder “Disneyland” are shown.

The names of the folders are also displayed as titles thereof, as shown in FIG. 5. Instead of the folder names, the time period of the summer vacation “7/29˜8/4” may be displayed. Alternatively, the first day and the last day of the time period “7/29.8/4”, or each of the days may be displayed as the titles. Furthermore, if the time period of the event is longer than a predetermined period (such as one week), the first day and the last day of the event may be displayed as the titles.

In the case where the image data sets S0 have been classified erroneously, the classification result needs to be changed. In this case, the user 1 changes the folder to which each of the erroneously classified image data sets S0 is input, by using the personal computer 10. More specifically, by clicking the corresponding thumbnail image and moving the thumbnail image to the desired folder by a drag-and-drop operation, the folder of the corresponding image data set S0 can be changed. A result of change is sent from the personal computer 10 to the Web server 23, and the Web server 23 corrects the classification information B0 according to the result of change.

The user 1 can display the classification result display page 50 shown in FIG. 5 by accessing the Web server 23 from the personal computer 10. However, in some cases, the user 1 may wish to display the classification result by accessing the Web server 23 from a mobile terminal such as a cellular phone or a PDA. Since a mobile terminal has a small screen, it is preferable for the classification result display page to be generated and displayed according to the mobile terminal. For example, the representative images shown in the folder icons maybe omitted, or only the folder structure shown in the left-side frame 50L is preferably displayed.

As has been described above, according to the first embodiment, the photography date information is obtained from the tag information T0 added to the image data sets S0, and the image data sets S0 are classified into the event described in the calendar information C0 and further classified into the groups, based on the photography date information and the calendar information C0. Therefore, even if the event such as the summer vacation lasts for days, the image data sets S0 can be classified into the groups.

In the above embodiment, the image data sets S0, the thumbnail image data sets ST0, and the classification information B0 are stored in the storage database 21. However, the image data sets S0, the thumbnail image data sets ST0, and the classification information B0 maybe stored in another storage database having a network connection to the image server 2. Alternatively, the image data sets S0, the thumbnail image data sets ST0, and the classification information B0 may be stored respectively in different storage databases.

A second embodiment of the present invention will be explained next. In the first embodiment described above, the calendar information C0 corresponding to the country or region in which the image data sets S0 are classified, or the calendar information C0 corresponding to the events of the user 1 who requests image classification is stored in the information database 22. In the second embodiment, the information database 22 stores the calendar information C0 corresponding to countries, regions, and users including the user 1, and the calendar information C0 of the country or region corresponding to the photography location or the calendar information C0 corresponding to the user information is obtained, based on the photography location information described in the tag information T0 or based on the user information. The calendar information C0 corresponding to the country in which the user 1 lives may be obtained based on the address of the user 1 included in the user information.

The calendar information C0 can be read based on the user information, if the calendar information C0 is stored in the information database 22 in relation to the user information sent by the user 1 together with the image data sets S0.

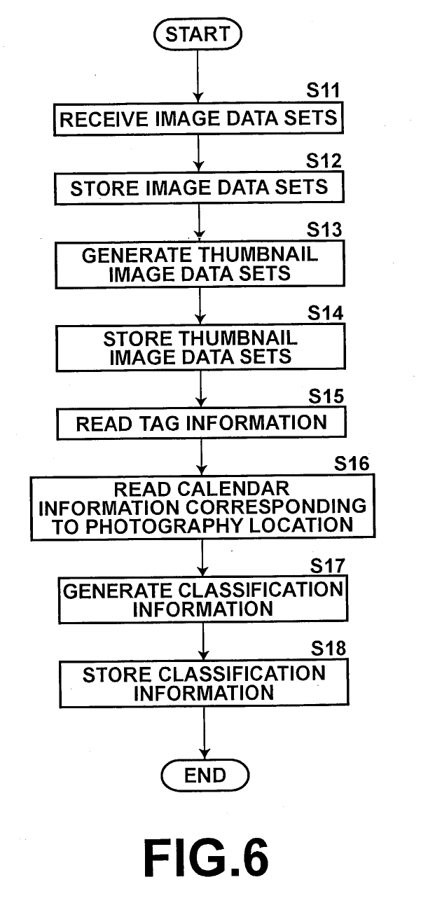

The operation of the second embodiment will be explained next. FIG. 6 is a flow chart showing the procedure carried out in the second embodiment. In the explanation below, the calendar information C0 corresponding to the country or region of photography location is obtained based on the photography location information described in the tag information T0.

The image data sets S0 obtained by photography by the user 1 with the digital camera 11 are sent from the personal computer 10 to the image storage server 2 via the network 3, and received by the image data input means 41 of the image storage server 2 (Step S11). The image data sets S0 are stored in the storage database 21 (Step S12), and the thumbnail image generation means 24 generates the thumbnail image data sets ST0 from the image data sets S0 (Step S13). The thumbnail image data sets ST0 are also stored in the storage database 21 (Step S14).

Meanwhile, the tag information reading means 42 reads the tag information T0 added to the image data sets S0 (Step S15). The tag information is input to the image classification means 43. The image classification means 43 reads the calendar information C0 of the country or region corresponding to the photography location from the information database 22, based on the photography location information described in the tag information T0 (Step S16). The image classification means 43 then classifies the image data sets according to the photography location information included in the tag information T0 and the calendar information C0, as has been described above, and generates the classification information B0 (Step S17). The classification information B0 is stored in the storage database 21 (Step S18) to end the procedure.

As has been described above, in the second embodiment, the calendar information C0 corresponding to the photography location is read from the calendar information C0 stored in the information database 22, based on the photography location information described in the tag information T0 of the image data sets S0. Therefore, the image data sets S0 can be classified according to the event corresponding to the photography location.

For example, if the user 1 carried out photography with the digital camera 11 during a trip in the United States on the Easter holidays, the photography location can be identified as the United States with reference to the photography location information. Therefore, the calendar information C0 corresponding to the United States is read from the information database 22. Since the calendar information C0 corresponding to the United States has the date of Easter, the image data sets S0 obtained by the user 1 during the Easter holidays in the United States are classified into the event of Easter, by referring to the calendar information C0 corresponding to the United States. Therefore, the image data sets S0 can be appropriately classified into the event corresponding to the whereabouts of the user.

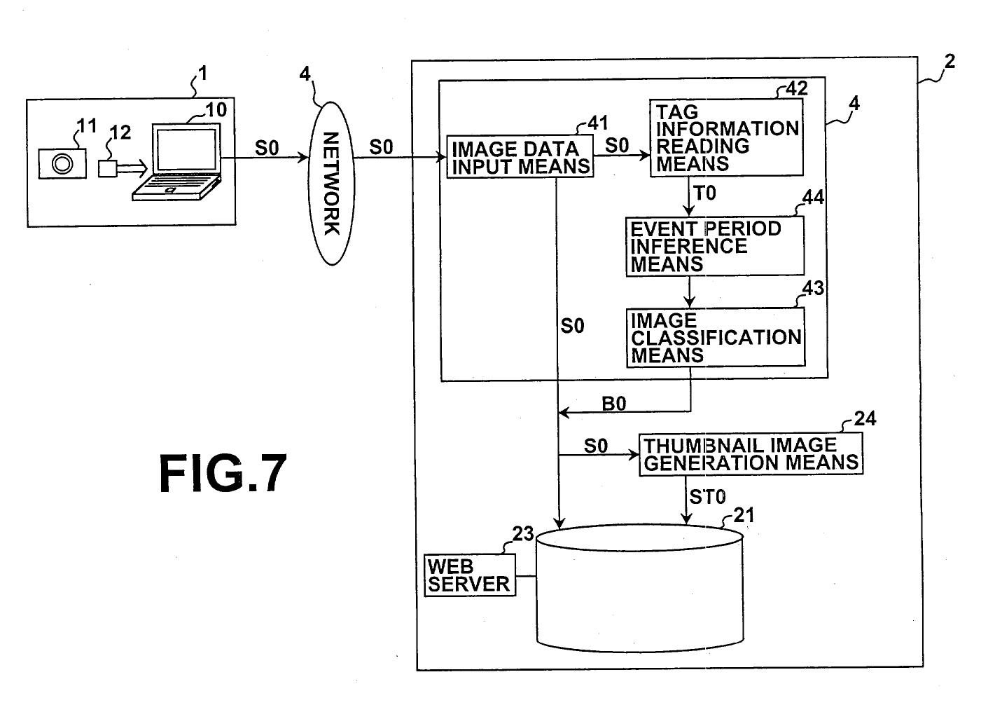

A third embodiment of the present invention will be explained next. In the first and second embodiments described above, the image data sets S0 are classified with use of the calendar information C0 stored in the information database 22. In the third embodiment, a time period of an event is inferred based on the various kinds of information described in the tag information T0 added to the image data sets S0. The image data sets S0 are classified according to the event period that has been inferred. For this reason, in the third embodiment, the image classification means 4 in the image storage server 2 has event period inference means 44 as shown in FIG. 7, for inferring the event period based on the information described in the tag information T0, instead of the information database 22 that stores the calendar information C0.

The event period inference means 44 infers a period as the event period in the case where the image data sets S0 have been obtained at the same photography location for the time period, based on the photography location information and the photography date information described in the tag information T0. Furthermore, in the case where the information representing the number of human faces is included in the tag information T0, a time period in which the image data sets were obtained is inferred as the event period in which the user 1 went out with his/her friends if the image data sets S0 represents images of a predetermined number of human faces or more.

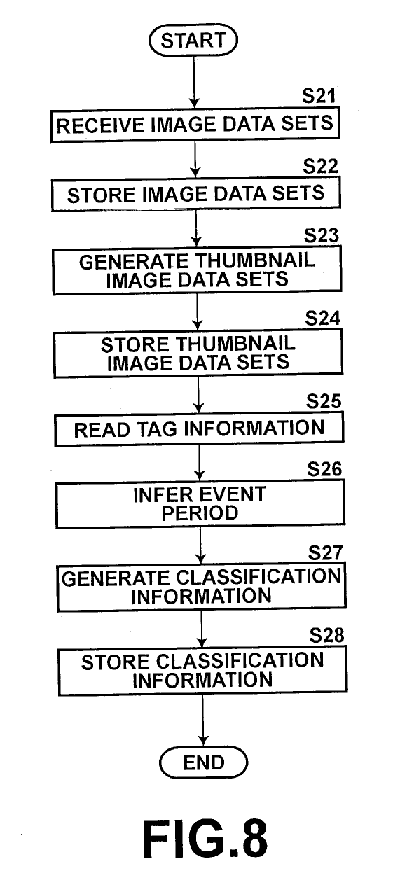

The operation of the third embodiment will be explained next. FIG. 8 is a flow chart showing the procedure carried out in the third embodiment. In this example, the event period is inferred based on the photography location information and the photography date information described in the tag information T0.

The image data sets S0 obtained by photography by the user 1 with the digital camera 11 are sent from the personal computer 10 to the image storage server 2 via the network 3, and received by the image data input means 41 of the image storage server 2 (Step S21). The image data sets S0 are stored in the storage database 21 (Step S22), and the thumbnail image generation means 24 generates the thumbnail image data sets ST0 from the image data sets S0 (Step S23). The thumbnail image data sets ST0 are also stored in the storage database 21 (Step S24).

Meanwhile, the tag information reading means 42 reads the tag information T0 added to the image data sets S0 (Step S25). The tag information is input to the event period inference means 44. The event period inference means 44 infers the event period, based on the photography location information and the photography date information described in the tag information T0 (Step S26). The image classification means 43 then classifies the image data sets S0 according to the photography date information described in the tag information T0 and the event period that has been inferred, as has been described above, and generates the classification information B0 (Step S27). The classification information B0 is stored in the storage database 21 (Step S28) to end the procedure.

As has been described above, in the third embodiment, the event period is inferred based on the various kinds of information described in the tag information T0. Therefore, the image data sets S0 can be classified by the event, even if the calendar information C0 is not stored in the information database 22, unlike the first or second embodiment. Therefore, the information database 22 becomes unnecessary, which leads to simplification of the image storage server configuration.

A fourth embodiment of the present invention will be explained next. In the fourth embodiment, the image data sets S0 are classified as in the third embodiment but with use of the calendar information C0 as well. For this reason, in the fourth embodiment, the image storage server 2 has the information database 22 that stores the calendar information C0, and the image classification means 4 has the event period inference means 44 for inferring the event period based on the information described in the tag information T0.

In the fourth embodiment, assume that the event period inference means 44 inferred three event periods July 2 to July 4, July 5, and July 8. The image classification means 43 reads the calendar information C0 based on the user information. In the case where the summer vacation of the user 1 was found to be from July 2 to July 8, the image data sets S0 are classified into the event of summer vacation from July 2 to July 8, and further classified into the event periods from July 2 to July 4, July 5, and July 8.

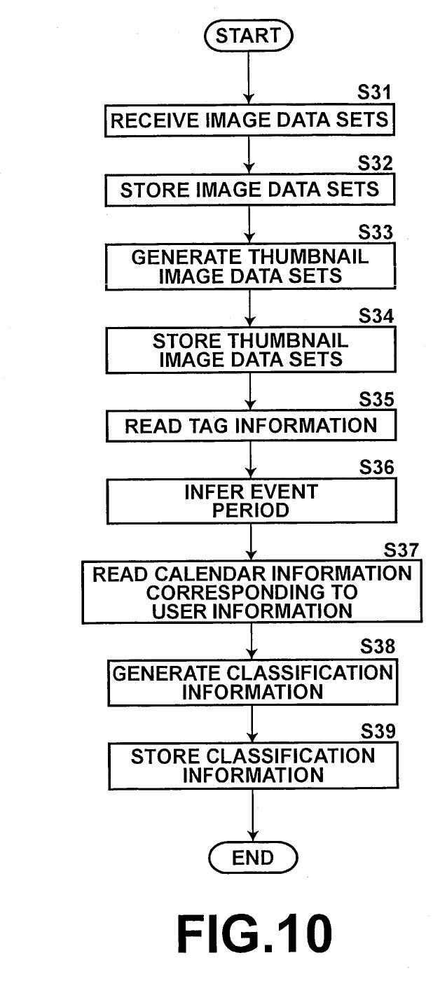

The operation of the fourth embodiment will be explained below. FIG. 10 is a flow chart showing the procedure carried out in the fourth embodiment. In the explanation below, the event period is inferred based on the photography location information and the photography date information described in the tag information T0, and the calendar information C0 is read according to the user information.

The image data sets S0 obtained by photography by the user 1 with the digital camera 11 are sent from the personal computer 10 to the image storage server 2 via the network 3, and received by the image data input means 41 of the image storage server 2 (Step S31). The image data sets S0 are stored in the storage database 21 (Step S32), and the thumbnail image generation means 24 generates the thumbnail image data sets ST0 from the image data sets S0 (Step S33). The thumbnail image data sets ST0 are also stored in the storage database 21 (Step S34).

Meanwhile, the tag information reading means 42 reads the tag information T0 added to the image data sets S0 (Step S35). The tag information is input to the event period inference means 44. The event period inference means 44 infers the event period (that is, the three event periods in the example described above), based on the photography location information and the photography date information described in the tag information T0 (step S36). The image classification means 43 refers to the user information, and reads the calendar information C0 corresponding to the user information from the information database 22 (Step S37).

The image classification means 43 then classifies the image data sets S0 according to the event period and the calendar information C0, as has been described above, and generates the classification information B0 (Step S38). The classification information B0 is stored in the storage database 21 (Step S39) to end the procedure.

As has been described above, in the fourth embodiment, the event period is inferred based on the information described in the tag information T0, and the image data sets S0 are classified according to the event period and the calendar information C0. Therefore, the image data sets S0 can be classified in detail based on the event period that is not described in the calendar information C0.

In the first to fourth embodiments described above, the user 1 sends the image data sets S0 from the personal computer 10 to the image storage server 2, and the image storage server 2 classifies the image data sets S0. However, if image classification software according to the image classification method of the present invention is installed in the personal computer 10, the user 1 may carry out classification of the image data sets S0 by himself/herself.

In this case, the image data sets S0 may be classified into the folders in the personal computer 10. However, only the classification information B0 may be stored therein so that the classification result can be displayed with use of only the thumbnail image data sets ST0 by referring to the classification information B0.

In the first to fourth embodiments, the image data sets S0 obtained by the user 1 with the digital camera 11 are classified. However, the image data sets S0 are not necessarily obtained by the digital camera 11, but may be obtained by reading images recorded on a negative film or the like.

In this case, the photography date information can be obtained by reading the date recorded on the images through character recognition and described in the tag information T0 of the image data sets S0. The photography location information and the user information can be input at the time of reading the image data sets S0.

The images may be read by a scanner owned by the user 1. Alternatively, the user 1 may request image reading from a laboratory that manages the image storage server 2 so that the laboratory can carry out the image reading.

In the case where the film is an APS film that can record magnetic information therein, the photography location information, the photography date information, and the user information is recorded at the time of photography in a magnetic recording unit thereof. The information described above is then read from the magnetic recording unit at the time of image reading so that the information can be described in the tag information T0.

What is claimed is:

1. An image classification method for classifying image data sets added with accompanying information including information on date and time of photography, the image classification method comprising the steps of:
obtaining the information on the date and time of photography from the image data sets; and
classifying the image data sets into a group or groups corresponding to a predetermined event related to a plurality of dates of photography, based on the information on the date and time of photography.

2. An image classification method as defined in claim 1 further comprising the step of obtaining calendar information that relates the predetermined event to the dates of photography, wherein
the step of classifying the image data sets is the step of classifying the image data sets according to the calendar information in addition to the information on the date and time of photography.

3. An image classification method as defined in claim 2, wherein the step of obtaining the calendar information is the step of obtaining the calendar information that relates the predetermined event to the dates of photography from calendar information storing means that stores a plurality of pieces of calendar information corresponding to a plurality of pieces of accompanying information.

4. An image classification method as defined in claim 3, wherein the step of obtaining the calendar information is the step of obtaining a desired one of the pieces of calendar information from the pieces of calendar information according to the accompanying information added to the image data sets, and the step of classifying the image data sets is the step of classifying the image data sets according to the desired piece of calendar information in addition to the information on the date and time of photography.

5. An image classification method as defined in claim 1, further comprising the step of inferring a time period of the predetermined event based on the accompanying information added to the image data sets, wherein
the step of classifying the image data sets is the step of classifying the image data sets according to a result of inference on the time period in addition to the information on the date and time of photography.

6. An image classification method as defined in claim 1, further comprising the step of classifying the image data sets that have been classified into groups having a hierarchical structure.

7. An image classification method as defined in claim 1, further comprising the step of outputting classification information representing a result of classification of the image data sets.

8. An image classification method as defined in claim 7, further comprising the step of displaying the image data sets in the classification according to the classification information.

9. An image classification apparatus for classifying image data sets added with accompanying information including information on date and time of photography, the image classification apparatus comprising:
photography date/time information obtaining means for obtaining the information on the date and time of photography from the image data sets; and
image classification means for classifying the image data sets into a group or groups corresponding to a predetermined event related to a plurality of dates of photography, based on the information on the date and time of photography.

10. An image classification apparatus as defined in claim 9, wherein the image classification means obtains calendar information that relates the predetermined event to the dates of photography and classifies the image data sets according to the calendar information in addition to the information on the date and time of photography.

11. An image classification apparatus as defined in claim 10 further comprising calendar information storing means for storing a plurality of pieces of calendar information corresponding to a plurality of pieces of accompanying information, wherein
the image classification means obtains the calendar information that relates the predetermined event to the dates of photography from the calendar information storing means.

12. An image classification apparatus as defined in claim 11, wherein the image classification means obtains a desired one of the pieces of calendar information from the pieces of calendar information according to the accompanying information added to the image data sets, and classifies the image data sets according to the desired piece of calendar information in addition to the information the on date and time of photography.

13. An image classification apparatus as defined in claim 9 further comprising event period inference means for inferring a time period of the predetermined event based on the accompanying information added to the image data sets, wherein
the image classification means also classifies the image data sets according to a result of inference on the time period.

14. An image classification apparatus as defined in claim 9, wherein the image classification means further classifies the image data sets that have been classified into groups having a hierarchical structure.

15. An image classification apparatus as defined in claim 9 further comprising output mans for outputting classification information representing a result of classification of the image data sets.

16. An image classification apparatus as defined in claim 15 further comprising display means for displaying the image data sets in the classification according to the classification information.

17. A program that causes a computer to execute an image classification method for classifying image data sets added with accompanying information including information on date and time of photography, the program comprising the steps of:
obtaining the information on the date and time of photography from the image data sets; and
classifying the image data sets into a group or groups corresponding to a predetermined event related to a plurality of dates of photography, based on the information on the date and time of photography.

18. A program as defined in claim 17 further comprising the step of obtaining calendar information that relates the predetermined event to the dates of photography, wherein
the step of classifying the image data sets is the step of classifying the image data sets according to the calendar information in addition to the information on the date and time of photography.

19. A program as defined in claim 18, wherein the step of obtaining the calendar information is the step of obtaining the calendar information that relates the predetermined event to the dates of photography from calendar information storing means that stores a plurality of pieces of calendar information corresponding to a plurality of pieces of accompanying information.

20. A program as defined in claim 19, wherein the step of obtaining the calendar information is the step of obtaining a desired one of the pieces of calendar information from the pieces of calendar information according to the accompanying information added to the image data sets and
the step of classifying the image data sets is the step of classifying the image data sets according to the desired piece of calendar information in addition to the information on the date and time of photography.

21. A program as defined in claim 17 further comprising the step of inferring a time period of the predetermined event based on the accompanying information added to the image data sets, wherein
the step of classifying the image data sets is the step of classifying the image data sets according to a result of inference on the time period in addition to the information on the date and time of photography.

22. A program as defined in claim 17, further comprising the step of classifying the image data sets that have been classified into groups having a hierarchical structure.

23. A program as defined in claim 17, further comprising the step of outputting classification information representing a result of classification of the image data sets.

24. A program as defined in claim 23, further comprising the step of displaying the image data sets in the classification according to the classification information.
